(19) United States
(12) Patent Application Publication
(10) Pub. No.: US 2021/0276567 A1
(43) Pub. Date: Sep. 9, 2021

(54) METHOD FOR ADAPTING A MAN-MACHINE INTERFACE IN A TRANSPORTATION VEHICLE AND TRANSPORTATION VEHICLE

(71) Applicant: VOLKSWAGEN AKTIENGESELLSCHAFT, Wolfsburg (DE)

(72) Inventors: Ina OTHERSEN, Bremen (DE); Sebastian HINZMANN, Meerdorf (DE); Ina PETERMANN-STOCK, Wolfsburg (DE); Amelie STEPHAN, Braunschweig (DE)

(21) Appl. No.: 16/319,955

(22) PCT Filed: Jun. 28, 2017
(86) PCT No.: PCT/EP2017/065964

§ 371 Date: Jan. 23, 2019

(30) Foreign Application Priority Data
Aug. 3, 2016 (DE) 10 2016 214 394.8

(51) Int. Cl. B60W 40/08; B60W 50/08; B60W 50/14; B60K 35/00

(52) U.S. Cl. CPC B60W 40/08; B60W 50/085; B60W 50/14; B60K 35/00; B60K 2370/186; B60W 2540/223; B60W 2540/225; B60K 2370/175; B60W 2540/22

(57) ABSTRACT

A method for adapting a man-machine interface in a transportation vehicle, wherein the transportation vehicle is operated in at least one automated driving mode, wherein a degree of confidence of the driver is detected or determined, and wherein the man-machine interface is adapted as a function of the detected or determined degree of confidence. Also disclosed is a transportation vehicle.

### PRIORITY CLAIM

This patent application is a U.S. National Phase of International Patent Application No. PCT/EP2017/065964, filed 28 Jun. 2017, which claims priority to German Patent Application No. 10 2016 214 394.8, filed 3 Aug. 2016, the disclosures of which are incorporated herein by reference in their entireties.

### SUMMARY

Illustrative embodiments relate to a method for adapting a human-machine interface in a transportation vehicle and to a transportation vehicle.

### BRIEF DESCRIPTION OF THE DRAWINGS

The disclosed embodiments are described in further detail in connection with the figures, which show:

FIG. 1 shows a schematic drawing of an interior compartment of a transportation vehicle;

FIG. 2 shows a schematic block wiring diagram of a device for adapting a human-machine interface; and

FIG. 3 shows a drawing of a transportation vehicle.

### DETAILED DESCRIPTION

In the future, different levels of automation in a transportation vehicle will be available, which gradually take over the control activity from the driver. The spectrum ranges from manual driving via assisted states up to fully automated functions. The driver is consequently located within a spectrum of assistance and automation. Changing between the individual degrees of automation and the consequent shift of responsibility represent a major new challenge for the driver.

The areas of semi-automated and highly automated driving must be clearly communicated. In both stages, the transportation vehicle performs the transverse and longitudinal guidance.

However, the role of the driver varies. In a semi-automatic system, the driver must be monitoring constantly and be ready to take immediate control of the transportation vehicle guidance. It thus represents the critical fallback level. In the highly automated mode, the driver does not need to monitor the system permanently and can attend to other activities. The driver must be prepared to take control of the transportation vehicle within a defined time window (approximately 10 seconds).

To make automated driving for the transport of the future safe and easy to use for all user groups, the interaction and communication between a human being and the machine interface must be designed to be context-sensitive. The objective is to return the driver safely back to the manual driving task after the automated driving, or to guide the driver safely from the manual to the automated driving mode. Central in this context are control, confidence and knowledge about the system state of the transportation vehicle—that is to say, the clear communication of the shift of responsibility between the driver and the automation system. In the long term, it is necessary to secure the confidence of the users in the automated driving function to ensure the user acceptance of the function.

DE 10 2013 110 864 A1 discloses a method for a driver assistance system of a transportation vehicle, wherein the driver assistance system is capable of controlling the transportation vehicle at least partly automatically using an autopilot function, wherein an activation state of the autopilot function is determined and a display device of the driver assistance system is activated as a function of the activation state of the autopilot function. For example, the display device is mechanically moved, so that this is visible in the activated state of the autopilot function and in the deactivated state it is retracted such that it is not visible. On the basis of the activated or deactivated display device the user can then very easily and quickly detect the activation state of the autopilot function. Information from the autopilot function can thus be output on the display device. The information from the autopilot function can comprise, for example, the remaining duration of an automatically controlled journey using the autopilot function. Alternatively or additionally, a future driving maneuver, which was determined by the autopilot function for the automatically controlled journey, can be output on the display device. In addition, an item of environmental information can alternatively or additionally be output. When the display device is activated, the driver and the occupants of the transportation vehicle thus receive a diverse range of information from the autopilot function, which can increase confidence in the autopilot function and thus the acceptance of this novel function.

DE 10 2013 224 118 A1 discloses a method for controlling a transportation vehicle, wherein behavioral information of a driver in the transportation vehicle is obtained via at least one detection device, wherein a control status of the transportation vehicle is changed depending on the behavioral information. This control status of the transportation vehicle comprises a driver control status, a semi-autonomous control status and an autonomous control status.

The technical problem addressed by the disclosed embodiments is to adapt a human-machine interface in a transportation vehicle so that the acceptance of an automated driving mode is further increased. A further technical problem is the creation of such a transportation vehicle.

Disclosed embodiments provide a method and a device.

The method for adapting a human-machine interface in a transportation vehicle, wherein the transportation vehicle can be operated in at least one automated driving mode, has the following method operations:
A degree of confidence of the driver in the automated driving mode is detected or determined and
the human-machine interface is adapted as a function of the detected or determined degree of confidence.

This ensures that in the event of a still low degree of confidence, the human-machine interface is adapted in such a way that the user can more easily build confidence, wherein on the other hand, for a user with a high degree of confidence the adaptation is primarily aimed at disturbing the user as little as possible. In the simplest case, only two degrees of confidence exist, namely “high” and “low” or “expert” and “novice”. However, other gradations are possible. It is also possible to determine the degree of confidence in a continuous manner, for example, as a percentage value between 0% and 100%. In this case it can also be provided that the transportation vehicle has a plurality of automated driving modes, wherein the method proceeds in all, in individual or only in one automated driving mode, for example, the driving mode with the highest degree of automation. The human-machine-interface can have at least one display unit, wherein different display units may be used. For example, one display unit can be a freely programmable instrument cluster, one display unit a head-up display and one display unit a central display unit. Alternatively or additionally, a rear-view mirror has at least one display unit. Furthermore, the human-machine interface can have a voice input and output unit.

Audio and visual animations may be an integral part of the human-machine-interface and can be adapted as a function of the degree of confidence.

In at least one disclosed embodiment, in the case of a relatively high degree of confidence, fewer information and/or interaction prompts are output. For example, in the case of a relatively high degree of confidence a display unit will only display the system status and duration and/or length of the piloted journey, whereas with a lower degree of confidence driving maneuvers and/or justifications for driving maneuvers and/or action instructions are additionally output. If speech output is used it can be provided that when there is a low degree of confidence the driver receives direct action instructions for activation or deactivation of the automated driving mode, for example, “To activate press both steering wheel buttons simultaneously”.

In at least one disclosed embodiment, the user inputs the degree of confidence him/herself via an input element, so that the degree of confidence is detected. In an alternative disclosed embodiment, by contrast, the degree of confidence is determined from control actions and/or an evaluation of the viewing direction of a driver. For example, if directly after activating the autopilot mode the driver actively attends to multimedia content, then a higher degree of confidence can be assumed. But the adjustment of the seat into a rest position is also an operator action that allows a high degree of confidence to be concluded. Alternatively or additionally, the viewing direction can be evaluated with a camera. Thus, for example, constantly viewing a central display (e.g., where a movie is playing) despite changing lanes expresses a high degree of confidence. Also, a calm eye movement, not monitoring the driving task suggests a high degree of confidence. On the other hand, frequent glances in the mirrors or at the display units showing the system status suggest a lower degree of confidence.

In a further disclosed embodiment a seat can be moved into a rest position, for example, and/or a central console can be moved as a function of the degree of confidence.

In a further disclosed embodiment at least one graphical interface of at least one display unit is adapted as a function of the degree of confidence. Alternatively, it can be provided that at least one display unit is controlled as a function of the degree of confidence in such a way that the unit is no longer visible to the user. For example, the display unit is retracted or a mechanical cover is moved in front of the display unit. It can also be provided that a rear-view mirror has two display units arranged side-by-side, wherein in a non-automated driving mode, images from a rear-view camera are displayed. In the automated driving mode, for a low degree of confidence it can be provided that information is displayed in one of the two display units, whereas the other display unit continues to be activated as a mirror. In the case of a high degree of confidence, by contrast, both display units can be used for displaying information.

The transportation vehicle with a human-machine interface, wherein the transportation vehicle is designed in such a way that the transportation vehicle can be operated in at least one automated driving mode, has an evaluation and control unit which is designed in such a way that a degree of confidence of the driver is detected or determined, wherein the human-machine interface is adapted as a function of the detected or determined degree of confidence.

With regard to the further designs, reference is made to the previous embodiments.

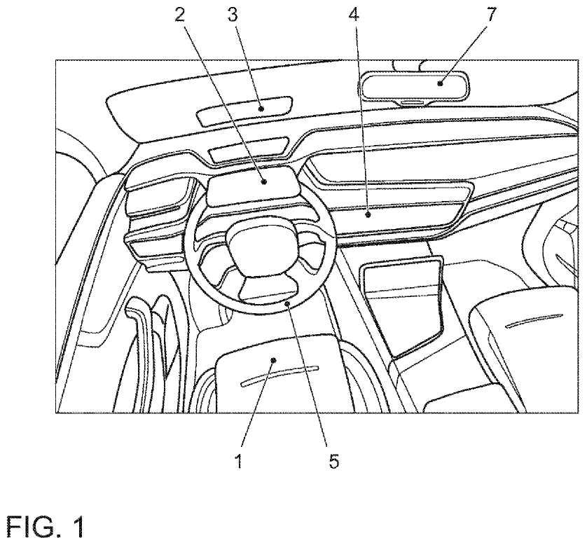

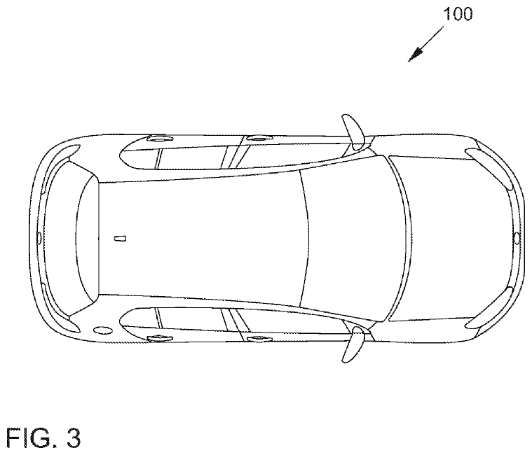

FIG. 1 illustrates part of an interior of a transportation vehicle 100 (see FIG. 3), wherein the transportation vehicle 100 can be operated in at least one automated driving mode. In this example, the transportation vehicle 100 has a seat 1 which is shown in a rest position, for which purpose the seat is rotated by 180° from the normal position. Further, the transportation vehicle 100 has a freely programmable instrument cluster 2, a head-up display 3 and a central display unit 4. In front of the freely programmable instrument cluster 2 a movable steering wheel 5 is arranged, which may be fitted with input elements that are not shown. Further, the transportation vehicle 100 has an adjustable central console 6 and a rear-view mirror 7, which may have two display units that are controllable separately from each other.

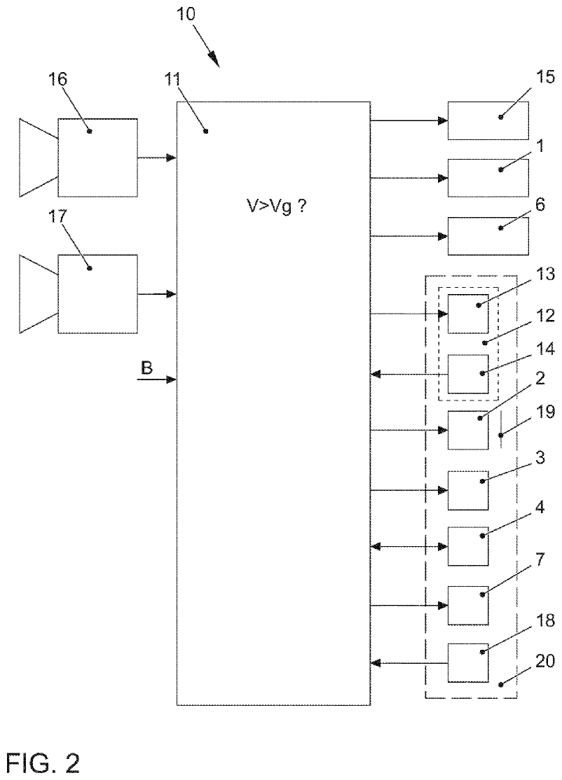

The operation will now be explained on the basis of the block wiring diagram according to FIG. 2, which shows a device 10 for adapting a human-machine interface. The device 10 comprises an evaluation and control unit 11. In addition to the elements already explained in relation to FIG. 1, the device 10 has a voice input and output unit 12 with at least one speaker 13 and at least one microphone 14. The device 10 also has an actuator 15 for implementing at least one automated driving mode. The device 10 also comprises a camera 16 for recording following traffic and a camera 17 for driver monitoring. Finally, the device also has input elements 18, which are arranged, for example, on the steering wheel 5 (see FIG. 1), and an adjustable cover 19 in the region of the freely programmable instrument cluster 2. The freely programmable instrument cluster 2, the head-up display 3, the central display unit 4, the rear-view mirror 7, the voice input and output unit 12 and the input elements 18 together form the human-machine interface 20.

If a driver now switches on an automated driving mode via the input elements 18, or if this is automatically selected by the transportation vehicle, then the evaluation and control unit 11 examines a degree of confidence V of the driver in the automated driving mode. For the sake of simplicity, it is assumed here that the degree of confidence V is binary, i.e., either it is high V>Vg or low V<Vg. The degree of confidence V can be entered by the driver him/herself (e.g., via the input elements 18, the microphone 14 or the central display unit 4, which is designed as a touch screen, for example). If the driver inputs that he/she only has a low degree of confidence V, then the driver will receive comprehensive information to establish some confidence. For example, it can be stipulated that the rear-view mirror 7 also shows images from the camera 16 on one of its two display units. In the freely programmable instrument cluster 2, station information and explanations for driving maneuvers are offered.

If on the other hand, the degree of confidence V>Vg, the driver receives only a small amount of information in the automated driving mode. For example, the voice output is limited to the essential information only (e.g., an overtaking prompt). The cover 19 is moved over the instrument cluster 2 and the entire rear-view mirror 7 is used for displaying information. The seat 1 can be moved into the rest position automatically or after an input. The central console 6 also can be moved either automatically or on request.

Alternatively, the degree of confidence V can be determined, for example, by carrying out evaluations of the viewing direction of the driver, which is detected by the camera 17. In addition or alternatively, user actions B can also be evaluated. Other possibilities are, for example, face evaluation or evaluation of bodily parameters (pulse, heart rate, skin resistance).

The basic principle involved is in the case of a low degree of confidence V to adapt the human-machine interface in such a way that the confidence of the driver is gained, whereas in the case of a high degree of confidence the driver should remain largely undisturbed, to enjoy the benefits of automated driving.

1. A method for adapting a human-machine interface in a transportation vehicle, wherein the transportation vehicle is operated in at least one automated driving mode, the method comprising:
detecting or determining a degree of confidence of the driver; and
adapting the human-machine interface as a function of the detected or determined degree of confidence.

2. The method of claim 1, wherein fewer information and/or interaction prompts are output via the human-machine interface in response to a higher degree of confidence.

3. The method of claim 1, wherein the degree of confidence is determined based on control actions and/or an evaluation of the viewing direction of a driver.

4. The method of claim 1, further comprising moving a seat and/or a central console is as a function of the degree of confidence.

5. The method of claim 1, wherein at least one graphical interface of at least one display unit is adapted as a function of the degree of confidence.

6. A transportation vehicle that includes at least one automated driving mode, the transportation vehicle comprising:
a human-machine interface; and
an evaluation and control unit, which detects or determines a degree of confidence of the driver of the transportation vehicle,
wherein the human-machine interface is adapted as a function of the detected or determined degree of confidence.

7. The transportation vehicle of claim 6, wherein fewer information and/or interaction prompts are output by the evaluation and control unit in response to a higher degree of confidence.

8. The transportation vehicle of claim 6, wherein the evaluation and control unit is designed so that the degree of confidence is determined based on control actions and/or an evaluation of the viewing direction of a driver.

9. The transportation vehicle of claim 6, the further comprising a seat that is moved into a rest position and/or with a moveable central console, wherein the evaluation and control unit is designed so that the seat and/or the central console is moved, or the ability to move is enabled as a function of a degree of confidence.

10. The transportation vehicle of claim 6, wherein the evaluation and control unit is designed so that at least one graphical interface of at least one display unit is adapted as a function of the degree of confidence.
